(19) United States
(12) Patent Application Publication
(10) Pub. No.: US 2007/0091016 A1
(43) Pub. Date: Apr. 26, 2007

(54) Plasma display device and its driving method

(76) Inventors: Du-Yeon Han, Suwon-si (KR); Nam-Sung Jung, Suwon-si (KR)

Correspondence Address: Robert E. Bushnell;Suite 300, 1522 K Street, N.W., Washington, DC, 20005, US

(21) Appl. No.: 11/523,608

(22) Filed: Sep. 20, 2006

(30) Foreign Application Priority Data
Oct. 6, 2005 (KR) 10-2005-0093816

(51) Int. Cl. G09G 3/28

(52) U.S. Cl. 345/60

(57) ABSTRACT

In a plasma display device, a plurality of row electrodes are divided into first and second row electrode groups, and the respective first and second row electrode groups are divided into a plurality of sub-groups. In respective subfields of one field, an operation of an address period is performed for the respective sub-groups of the first and second row electrode groups, and an operation of a sustain period is performed between the address periods of the respective sub-groups. In addition, the operation of the address period is performed for the respective sub-groups of the second row electrode group while the operation of the sustain period is performed for the respective sub-groups of the first row electrode group, and the operation of the sustain period is performed for the respective sub-groups of the first row electrode group while the operation of the address period is performed for the respective sub-groups of the second row electrode group.

### CLAIM OF PRIORITY

This application makes reference to, incorporates the same herein, and claims all benefits accruing under 35 U.S.C. §119 from an application for PLASMA DISPLAY AND DRIVING METHOD THEREOF earlier filed in the Korean Intellectual Property Office on the 6^{th} of Oct. 2005 and there duly assigned Serial No. 10-2005-0093816.

### BACKGROUND OF THE INVENTION

1. Field of the Invention

The present invention relates to a plasma display device and its driving method.

2. Description of the Related Art

A plasma display device is a flat panel display that uses plasma generated by a gas discharge process to display characters or images. It includes a plurality of discharge cells arranged in a matrix pattern.

On a panel of the plasma display device, a field (e.g., 1 TV field) is divided into a plurality of subfields respectively having a weight. Grayscales are expressed by a combination of weights from among the subfields, which are used to perform a display operation. Each subfield has an address period in which an address operation for selecting discharge cells to emit light and discharge cells to emit no light from among a plurality of discharge cells is performed. Each subfield also includes a sustain period where a sustain discharge occurs in the selected discharge cells to perform a display operation during a period corresponding to a weight of the subfield.

Such a plasma display device uses subfields respectively having a different weight value to express respective grayscales. Grayscales are expressed by a sum of weight values of the subfields of the light-emitting discharge cells, among the plurality of subfields. For example, when subfields respectively have a weight value in the format of a power of 2, and a 127 grayscale and a 128 grayscale are respectively expressed in two subsequent frames of one discharge cell, a dynamic false contour can occur.

When the address period and the sustain period are divided with respect to time, a length of one subfield may increase since an address period for addressing all the discharge cells is formed in the respective subfields in addition to the sustain period for sustain discharging. Accordingly, the number of subfields used in one subfield is limited since the length of the subfield is increased.

### SUMMARY OF THE INVENTION

The present invention has been made in an effort to provide a plasma display device for reducing a false contour and a length of a subfield, and its driving method.

These and other objects of the present invention can be achieved by providing a method of driving a plasma display device by a plurality of subfields divided from one field, the plasma display device including a plurality of row electrodes, a plurality of column electrodes, and a plurality of discharge cells respectively defined by the plurality of row electrodes and the plurality of column electrodes, the method including: dividing the plurality of row electrodes into a first row electrode group and a second row electrode groups, dividing the first row electrode group into a plurality of first sub-groups, and dividing the second row electrode group into a plurality of second sub-groups; sustain-discharging a light emitting cell of at least one second sub-group selected from among the plurality of second sub-groups during a first period respectively corresponding to at least one second sub-group while selecting a non-light emitting cell from among light emitting cells of one first sub-group selected from among the plurality of first sub-groups, in respective first subfields of first subfield groups selected from among the plurality of subfields; and sustain-discharging a light emitting cell of at least one first sub-group selected from among the plurality of first sub-groups during a second period respectively corresponding to at least one first sub-group while selecting a non-light emitting cell from among the light emitting cells of one second sub-group selected from among the plurality of second sub-groups, in the respective first subfields; the sustain-discharging of the light emitting cell of the at least one second sub-group further includes supplying a first sustain pulse and a second sustain pulse respectively having an opposite phase of a high level voltage and a low level voltage to a first electrode and a second electrode of the light emitting cell of the at least one second sub-group at least once; and the selecting of the non-light emitting cell from among the light emitting cells of the one first sub-group further includes supplying a first address pulse to a third electrode of the one sub-group while supplying either the high level voltage or the low level voltage to the first and second electrodes.

The first address pulse is preferably not supplied during at least one period selected from either a period in which the first sustain pulse and the second sustain pulse are increased from the low level voltage to the high level voltage or a period in which the first sustain pulse and the second sustain pulse are decreased from the high level voltage to the low level voltage.

In at least one first subfield selected from among the first subfield group, the light emitting cells of the plurality of the second sub-groups are preferably sustain-discharged during the first period, and the light emitting cells of the plurality of first sub-groups are preferably sustain-discharged during the second period.

In at least one first subfield selected from among the first subfield group, the first period preferably corresponds to a period for selecting the non-light emitting cell from among the light emitting cells of the one first sub-group.

In at least one first subfield selected from among the first subfield group, the light emitting cell of the at least one second sub-group is preferably not sustain-discharged during the period for selecting the non-light emitting cell from among the light emitting cells of the one first sub-group except for the first period, and the light emitting cell of the at least one first sub-group is preferably not sustain-discharged during the period for selecting the non-light emitting cell from among the light emitting cells of the one second sub-group except for the second period.

In at least one first subfield of the first subfield group, the second sub-groups except for the at least one second sub-group selected from among the plurality of second sub-groups are preferably not sustain-discharged during the period for selecting the non-light emitting cell from among the light emitting cells of the one first sub-group.

The respective first subfields of the first subfield group preferably respectively have the same weight value.

Alternatively, some of the first subfields selected from among the first subfield group preferably respectively have the same weight value, and the remaining first subfields preferably respectively have a weight value that is lower than the weight value of the some of the first subfields.

The first row electrode group preferably includes the first electrodes provided on an upper part of the plasma display device and selected from among the plurality of first electrodes, and the second row electrode group preferably includes the first electrodes provided on a lower part of the plasma display device and selected from among the plurality of first electrodes.

These and other objects of the present invention can also be achieved by providing a plasma display device including: a Plasma Display Panel (PDP) including a plurality of first electrodes, a plurality of second electrodes, a plurality of third electrodes arranged in a direction crossing the first and second electrodes, and a plurality of cells defined by the first electrodes, the second electrodes, and the third electrodes; a controller adapted to divide one field into a plurality of subfields, to divide the plurality of first electrodes into a first group and a second group, to divide first electrodes of the first group into a plurality of first sub-groups, and to divide first electrodes of the second group into a plurality of second sub-groups; and a driver adapted to drive the plurality of first electrodes, the plurality of second electrodes, and the plurality of third electrodes; in respective subsequent first subfields selected from among the plurality of subfields, the driver is adapted to: select a non-light emitting cell from among light emitting cells of the respective first sub-groups during a first period for the respective first sub-groups, and to sustain-discharge a light emitting cell of at least one second sub-group selected from among the plurality of second sub-groups during a second period which is at least a part of the first period; select a non-light emitting cell from among light emitting cells of the respective second sub-groups during a third period for the respective second sub-groups, the third period being arranged between neighboring first periods, to supply a first sustain pulse and a second sustain pulse respectively having a high level voltage and a low level voltage in opposite phases to the first and second electrodes of the light emitting cell of the at least one first sub-group selected from among the plurality of first sub-groups during a fourth period, the fourth period being at least a part of the third period, and to sustain-discharge the first and second electrodes; and select the non-light emitting from among the light emitting cells of the one first sub-group by supplying a first address pulse to the third electrode of one sub-group while either the high level voltage or the low level voltage is supplied to the first and second electrodes.

The driver preferably does not supply the first address pulse during at least one period selected from either a period in which the first sustain pulse and the second sustain pulse are increased from the low level voltage to the high level voltage or a period in which the first sustain pulse and the second sustain pulse are decreased from the high level voltage to the low level voltage.

In a second subfield provided before the plurality of first subfields, the driver is preferably adapted to select a light emitting cell from among discharge cells of the first group, to sustain-discharge the light emitting cell of the first group, to select a light emitting cell from among discharge cells of the second group, and to sustain-discharge the light emitting cell of the second group.

The driver is preferably adapted to set the plurality of discharge cells to be in a non-light emitting cell state before selecting the light emitting cell in the second subfield.

The second period is shorter than the first period, and the fourth period is shorter than the third period. The second period is alternatively preferably equal to the first period, and the fourth period is equal to the third period.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of a plasma display device according to an exemplary embodiment of the present invention.

FIG. 2 is a table of an electrode division configuration applied to a driving method of the plasma display device according to the exemplary embodiment of the present invention.

FIG. 3 is a diagram representing a driving method of the plasma display device according to a first exemplary embodiment of the present invention.

FIG. 4 is a diagram representing subfields to describe the driving method of FIG. 3.

FIG. 5 are driving waveforms applied to the driving method of FIG. 3 of the plasma display device.

FIG. 6 and FIG. 7 are respective diagrams representing a method of expressing grayscales in the driving method of FIG. 3 according to first and second exemplary embodiments of the present invention.

FIG. 8A and FIG. 8B are respective waveform diagrams for realizing weight values of subfields SF1 to SF6.

FIG. 9 and FIG. 10 are respective diagrams representing a driving method of the plasma display device according to third and fourth exemplary embodiments of the present invention.

FIG. 11A and FIG. 11B are waveform diagrams of the plasma display device according to a fifth exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments can be modified in various different ways, all without departing from the spirit or scope of the present invention. Accordingly, the drawings and description are to be regarded as illustrative in nature and not restrictive. Like reference numerals designate like elements throughout the specification.

In addition, wall charges mentioned in the following description are charges formed and accumulated on a wall (e.g., a dielectric layer) close to an electrode of a discharge cell. A wall charge is described as being “formed” or “accumulated” on the electrode, although the wall charges do not actually touch the electrodes. Furthermore, a wall voltage is a potential difference formed on the wall of the discharge cell by the wall charge.

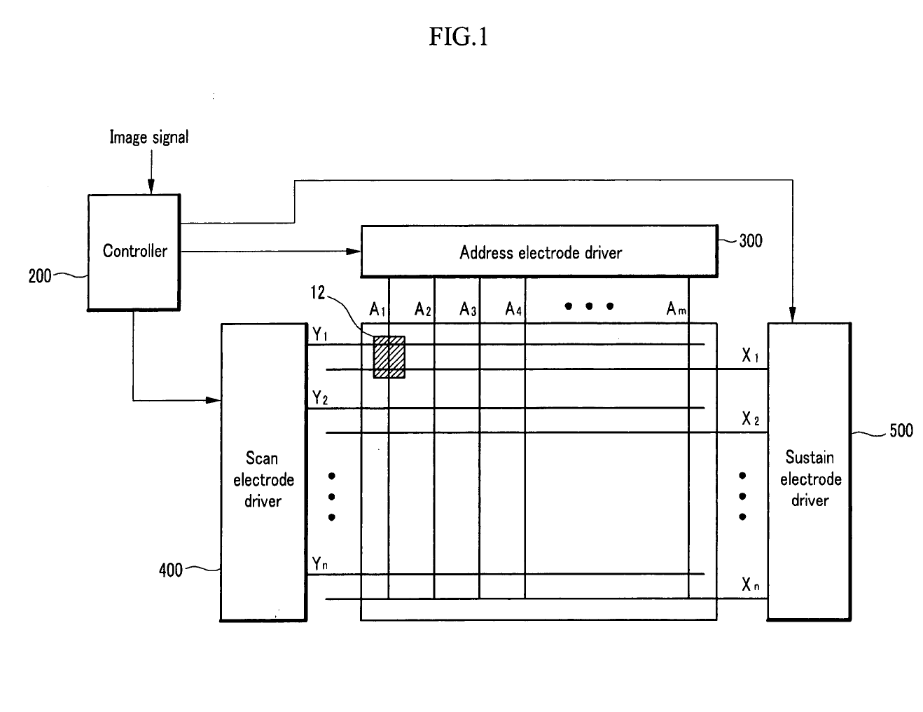

A plasma display device according to an exemplary embodiment of the present invention is described below with reference to FIG. 1.

FIG. 1 is a block diagram of a plasma display device according to an exemplary embodiment of the present invention.

As shown in FIG. 1, the plasma display device according to the exemplary embodiment of the present invention includes a Plasma Display Panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain and scan electrodes X1 to Xn and Y1 to Yn in pairs extending in a row direction. In general, the X electrodes X1 to Xn respectively correspond to the Y electrodes Y1 to Yn, and a display operation is effected by the X and Y electrodes during the sustain period. The Y and X electrodes Y1 to Yn and X1 to Xn are arranged perpendicular to the A electrodes A1 to Am. A discharge space formed at an area where the address electrodes Al to Am cross the sustain and scan electrodes X1 to Xn and Y1 to Yn forms a discharge cell 12. The configuration of the PDP 100 of FIG. 1 is one exemplary configuration, and other exemplary configurations can be applied to the present invention. The X and Y electrodes extending in pairs in a row direction will be referred to hereinafter as row electrodes, and the A electrodes extending in a column direction will be referred to hereinafter as column electrodes.

The controller 200 receives an external video signal and outputs an A electrode driving control signal, an X electrode driving control signal, and a Y electrode driving control signal. In addition, the controller 200 divides a frame into a plurality of subfields respectively having a brightness weight value, and drives them. Furthermore, the controller 200 outputs a control signal so that the plurality of row electrodes can be divided into a first row electrode group and a second row electrode group, and the first and second row groups can be respectively divided into a plurality of sub-groups.

The address driver 300 receives an A electrode driving control signal from the controller 200, and supplies a display data signal to the respective A electrodes to select a discharge cell to be displayed.

The scan electrode driver 400 receives the Y electrode driving control signal from the controller 200 and supplies a driving voltage to the Y electrodes.

The sustain electrode driver 500 receives the X electrode driving control signal from the controller 200 and supplies a driving voltage to the X electrodes.

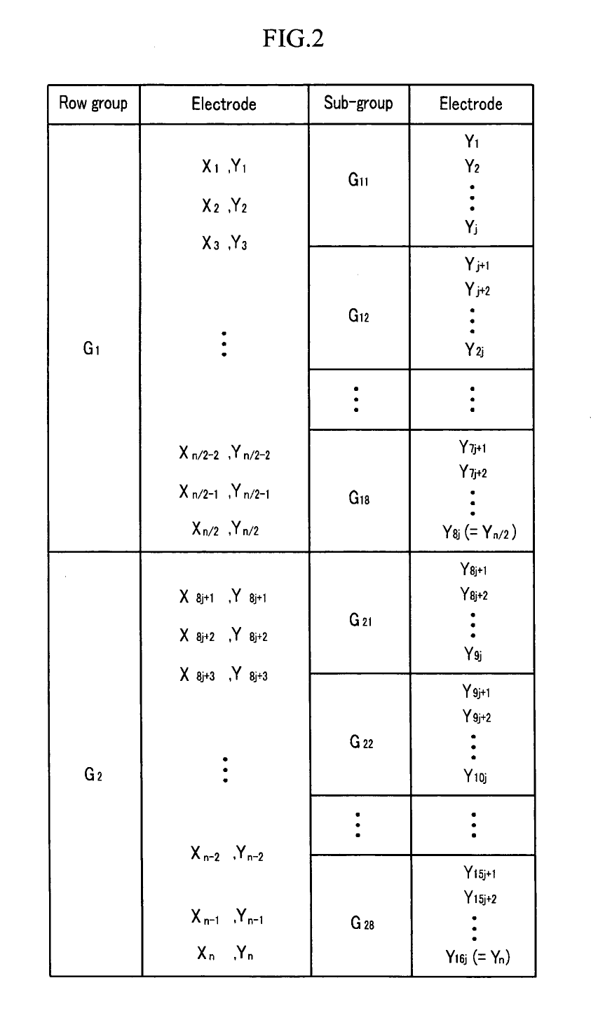

A method of driving the plasma display device according to the exemplary embodiment of the present invention is described below with reference to FIG. 2.

FIG. 2 is a table of an electrode division configuration applied to a driving method of the plasma display device according to the exemplary embodiment of the present invention.

As shown in FIG. 2, a plurality of row electrodes X₁ to Xₙ and Y₁ to Yₙ are divided into two row electrode groups G₁ and G₂. A first row electrode group G₁ includes a plurality of row electrodes X₁ to X_{n/2} and Y₁ to Y_{n/2} provided on an upper side of the PDP 100, and a second row electrode group includes a plurality of row electrodes X_{(n/2)+1} to Xₙ and Y_{(n/2)+1} to Yₙ provided on a lower side of the PDP 100. In addition, a plurality of Y electrodes among the respective first and second row electrode groups G₁ and G₂ are divided into a plurality of sub-groups G₁₁ to G₁₈ and G₂₁ to G₂₈. In FIG. 2, the respective first and second row electrode P58074 groups G₁ and G₂ are divided into eight sub-groups G₁₁ to G₁₈ and G₂₁ to G₂₈.

In addition, among the first row electrode group G₁, first to j^{th} Y electrodes Y₁ to Yⱼ are set to be a first sub-group G₁₁, and (j+1)^{th} to 2j^{th} Y electrode Yⱼ₊₁ to Y₂ⱼ are set to be a second sub-group G₁₂. As described above, an eighth sub-group G₈ includes (7j+1)^{th} to (n/2)^{th} Y electrodes Y₇ⱼ₊₁ to Y_{n/2} (here, j is an integer between 1 and n/16). In a like manner of the first row electrode group G₁, among the second row electrode group G₂, (8j+1)^{th} to 9j^{th} Y electrodes Y₈ⱼ₊₁, to Y₉ⱼ are set to be a first sub-group G₂₁, and (9j+1)^{th} and 10j^{th} Y electrodes Y₉ⱼ₊1, and Y₁₀ⱼ are set to be a second sub-group G₂₂. Accordingly, an eighth sub-group G₂₈ includes (15j+1)^{th} to n^{th} Y electrodes Y₁₅ⱼ₊₁ to Yₙ. Differing from the above, among the first and second row electrode groups G₁ and G₂, Y electrodes being apart from each other at a predetermined interval can form one sub-group, and Y electrodes can be irregularly grouped if necessary.

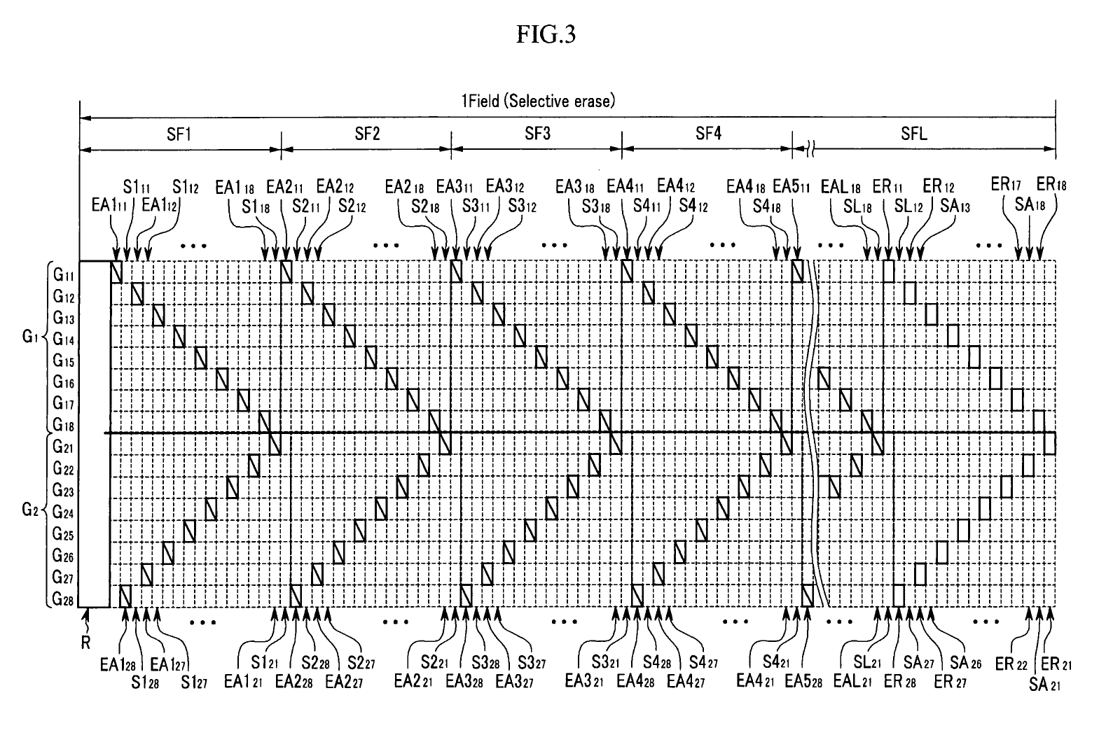

FIG. 3 is a diagram representing a driving method of the plasma display device according to a first exemplary embodiment of the present invention. In the first exemplary embodiment of the present invention, it is assumed that the lengths of an address period and a sustain period are the same, and the sustain period has the same length in all subfields.

As shown in FIG. 3, one field includes a plurality of subfields SF1 to SFL. First to L^{th} subfields SF1 to SFL respectively include address periods EA1₁₁ to EAL₁₈ and EA1₂₁ to EAL₂₈ and sustain periods S1₁₁ to SL₁₈ and S1₂₁ to SL₂₈, and the address periods EA1₁₁ to EAL₁₈ of the first to L^{th} subfields SF1 to SFL are formed in a selective erase address method. As described with reference to FIG. 2, the plurality of row electrodes X₁ to Xₙ and Y₁ to Yₙ are divided into the first and second row electrode groups G₁ and G₂, and the first and second row electrode groups G₁ and G₂ are respectively divided into the plurality of sub-groups G₁₁ to G₁₈ and G₂₁ to G₂₈.

A selective write method and a selective erase method can be used to select a discharge cell to emit light (hereinafter, referred to as a “light emitting cell”) and a discharge cell not to emit light (hereinafter, referred to as a “non-light emitting cell”) among a plurality of discharge cells. In the selective write method, a light emitting cell is selected and a predetermined wall voltage is formed, and, in the selective erase method, a non-light emitting cell is selected and a previously formed wall voltage is erased. That is, in the selective write method, a cell in a non-write emitting cell state is set to be in a light emitting cell state by address discharging the cell in the non-write emitting cell state and forming wall charges, and, in the selective erase method, a cell in the light emitting cell state is set to be in the non-light emitting cell state by address discharging the cell in the light emitting cell state and erasing the wall charges. Hereinafter, an address discharge for forming the wall charges in the selective write method will be referred to as a “write discharge”, and an address discharge for erasing the wall charges in the selective erase method will be referred to as an “erase discharge”.

Referring back to FIG. 3, a reset period R for setting all the discharge cells to be in the light emitting cell state by initializing all the discharge cells is provided right before the address period EA1₁₁ of the first subfield SF1 among the first to L^{th} subfields SF1 to SFL having the address periods EA1₁₁ to EAL₁₈ and EA1₂₁ to EAL₂₈ in the selective erase method. During the reset period R, all the discharge cells are initialized to be in the light emitting cell state so that the discharge cells can be erase discharged during the address period EA1.

Subsequently, operations of the address periods EA1₁₁ to EAL₁₈ and EA1₂₁ to EAL₂₈ and the sustain periods S1₁₁, to SL₁₈ and S1₂₁ to SL₂₈ of the first to eighth sub-groups G₁₁ to G₁₈ and G₂₁ to G₂₈ of the first and second row electrode groups G₁ and G₂ are sequentially performed in the first subfield SF1. In this case, the operations of the address periods EA1₁₁ to EAL₁₈ and the sustain periods S1₁₁ to SL₁₈ are sequentially performed from the first sub-group G₁₁ to the eighth sub-group G₁₈ in the respective subfields SF1 to SFL of the first row electrode group G₁, and the operations of the address periods EA1₂₈ to EAL₂₁ and the sustain periods S1₂₈ to SL₂₁ are sequentially performed from the eighth sub-group G₂₈ to the first sub-group G₂₁ in the respective subfields SF1 to SFL of the second row electrode group G₂. That is, in a k^{th} subfield SFk of the first row electrode group G₁, after an operation of an address period EAk₁ᵢ of an i^{th} sub-group G₁ᵢ is performed, an operation of a sustain period Sk₁ᵢ of an i^{th} sub-group is performed (here, k is an integer between 1 and L, and i is an integer between 1 and 8.). Subsequently, operations of an address period EAk₁₍ᵢ₊₁₎ and a sustain period Sk₁₍ᵢ₊₁₎ of a (i+1)^{th} sub-group G₁₍ᵢ₊₁₎ are performed. In the k^{th} subfield SFk of the second row electrode group G₂, an operation of an address period EAk₂ᵢ of a (i+1)^{th} sub-group G₂₍ᵢ₊₁₎ is performed, and then an operation of a sustain period Sk₂₍ᵢ₊₁₎ of a (i+1)^{th} sub-group G₂₍ᵢ₊₁₎ is performed. Subsequently, operations of an address period EAk₂ᵢ and a sustain period Sk₂ᵢ of an i sub-group G₂ᵢ are performed.

While an operation of the sustain period Sk₁ᵢ of the i^{th} sub-group G₁ᵢ of the first row electrode group G₁ is performed in the k^{th} subfield SFk, an operation of an address period EAk_{2 (8-(i-1)} of a (8−(i−1))^{th} sub-group G_{2 (8-(i-1)} of the second row electrode group G₂ is performed. In a like manner, while an operation of a sustain period Sk₂₍₈₋₍ᵢ₋₁₎ of the (8−(i−1))^{th} sub-group G₂₍₈₋₍ᵢ₋₁₎ of the second row electrode group G₂ is performed in the k^{th} subfield SFk, an operation of the address period EAk₁₍ᵢ₊₁₎ of the (i+1)^{th} sub-group G₁₍ᵢ₊₁₎ is performed in the first row electrode group G₁.

However, as shown in FIG. 3, while an operation of a sustain period Sk₂₁ of the first sub-group G₂₁ of the second row electrode group G₂ is performed in the kₜₕ subfield, an operation of an address period EA(k+1)₁₁ of a (k+1) subfield of the first sub-group G₁₁ is performed in the first row electrode group G₁.

While it has been illustrated that the operations of the address periods EA1₂₈ to EAL₂₁ and the sustain periods S1₂₈ to SL₂₁ are sequentially performed from the eighth sub-group G₂₈ to the first sub-group G₂₁ in the second row electrode group G₂ in FIG. 3, the operations of the address periods EA1₂₁ to EAL₂₈ and the sustain periods S1₂₁ to SL₂₈ can be sequentially performed from the first sub-group G₂₁ to the eighth sub-group G₂₈ in the second row electrode group G₂ in a like manner of the first row electrode group G₁. In addition, operations of the address and sustain periods can be performed in the first and second row electrode groups G₁ and G₂ in an order which is different from the order shown in FIG. 3.

The respective subfields SF1 to SFL of the first row electrode group G₁ will now be described. The operations of the address period and the sustain period in the respective subfields SF1 to SFL are substantially equivalent, and therefore an operation of the k^{th} subfield SFk will be described (here, k is an integer between 1 and L).

In the k^{th} subfield SFk, discharge cells for being set to be in the non-light emitting cell state among the light emitting cells of the first sub-group G₁₁ of the first row electrode group G₁ are erase discharged and wall charges thereof are erased during the address period EAk₁₁, and the remaining light emitting cells of the first sub-group G₁₁ are sustain discharged during the sustain period Sk₁₁. Subsequently, the discharge cells for being set to be in the non-light emitting cell state among the light emitting cells of the second sub-group G₁₂ are erase discharged and the wall charges thereof are erased during the address period EAk₁₂, and the remaining light emitting cells of the second sub-group G₁₂ are sustain discharged during the sustain period Sk₁₂. In this case, a sustain discharge is generated on the light emitting cells of the first sub-group G₁₁.

In a like manner, operations of the address periods EAk₁₃ to EAk₁₈ and the sustain periods Sk₁₃ to Sk₁₈ are performed for the remaining sub-groups G₁₃ to G₁₈. In this case, during the sustain period Sk₁ᵢ, the sustain discharge is generated on the light emitting cells of the i^{th} sub-group G₁ᵢ and the light emitting cells of the first to (i−1)^{th} sub-groups G₁₁ to G₁₍ᵢ₋₁₎ and the (i+1)^{th} to eighth sub-groups G₁₍ᵢ₊₁₎ to G₁₈. The light emitting cells of the first to (i−1)^{th} sub-groups G₁₁ to G₁₍ᵢ₋₁₎ have not been erase discharged during the respective address periods EAk₁₁ to EAk₁₍ᵢ₋₁₎ of the k^{th} subfield SFk, and the light emitting cells of the (i+1)^{th} to eighth sub-groups G₁₍ᵢ₊₁₎ to G₁₈ have not been erase discharged during the respective address periods EA(k−1)₁₍ᵢ₊₁₎ to EA(k−1)₁₈ of the (k−1)^{th} subfield SF(k−1). In addition, the light emitting cells of the i^{th} sub-group G₁ᵢ are sustain discharged before the address period EA3₁ᵢ of the i^{th} sub-group G₁ᵢ in the (k+1)^{th} subfield SF(k+1) (i.e., until the sustain period Sk₍ᵢ₋₁₎). That is, the sustain discharge is generated during eight sustain periods in the light emitting cell of the i^{th} sub-group G₁ᵢ.

As described, the operations of the address periods EA2₁₁ to EA2₁₈, . . . , and EAL₁₁ to EAL₁₈ and the sustain periods S2₁₁ to S2₁₈, . . . , and SL₁₁ to SL₁₈ are performed for the respective sub-groups G₁₁ to G₁₈ of the subfields SF1 to SFL. Accordingly, the discharge cells set to be in a light emitting cell state during the reset period R are continuously sustain discharged before they are erase discharged in the respective subfields SF1-SFL so that they are set to be in the non-light emitting cell state, and the discharge cells are not sustain discharged from a corresponding subfield in which the discharge cells are erase discharged and are set to be in the non-light emitting cell state. In this case, a weight value of the respective subfields SF1 to SFL corresponds to a sum of lengths of the eight sustain periods of the respective subfields SF1 to SFL.

The operation of sustain periods SA1₁₂ to SA1₁₈ can be additionally performed once to seven times for the respective second to eighth sub-groups G₁₂ to G₁₈ of the first row electrode group G₁ in the last subfield SFL so as to equalize the number of the sustain discharges in the respective sub-groups G₁₁ to G₁₈.

Accordingly, the additional sustain periods SA₁₂ to SA₁₈ can be respectively provided for the second to eighth sub-groups G₁₂ to G₁₈ in the last subfield SFL. To prevent the sustain discharge from the row electrode group on which the operation of the sustain period is performed eight times during the additional sustain periods SA₁₂ to SA₁₈, erase periods ER₁₁ to ER₁₇ for erasing wall charges formed in the previous sub-groups G₁₁-G₁₇ are provided before the additional sustain periods SA₁₂ to SA₁₈ of the respective sub-groups G₁₂ to G₁₈.

In addition, an erase period ER₁₈ for erasing wall charges of the eighth sub-group G₁₈ can be provided after the additional sustain period SA₁₈ of the eighth sub-group G₁₈. Since the operation of the reset period R is performed in the first subfield SF1 of a subsequent field, the erase period ER₁₈ of the eighth sub-group G₁₈ may not be provided. Furthermore, the operation of the erase periods ER₁₁ to ER₁₈ can be sequentially performed for the respective row electrodes of the respective sub-groups in a like manner of the address period, and can be concurrently performed for all the row electrodes of the respective row electrode groups.

In more detail, the operation of the sustain period SL₁₈ of the eighth sub-group G₁₈ of the first row electrode group G₁ is performed in the last subfield SFL, and then the wall charges formed in all the discharge cells of the first sub-group G₁₁ are erased during the erase period ER₁₁. Subsequently, the light emitting cells of the second to eighth sub-groups G₁₂ to G₁₈ are sustain-discharged during the additional sustain period SA₁₂. Following this, the wall charges formed in all the discharge cells of the second sub-group G₁₂ are erased during the erase period ER₁₂, and then the light emitting cells of the third to eighth sub-groups G₁₃ to G₁₈ are sustain discharged during the additional sustain period SA₁₃. The above process is continuously performed to the additional sustain period SA₁₈. Accordingly, the number of sustain discharges generated in the light emitting cells of the respective sub-groups G₁₁ to G₁₈ are the same.

A configuration of the respective subfields SF1 to SFL of the second row electrode group G₂ is the same as the configuration of the respective subfields SF1 to SFL of the first row electrode group G₁. However, as described above, the operation of the address periods EA1₂₈ to EA1₂₁, . . . , and EAL₂₈ to EAL₂₁ is sequentially performed from the eighth sub-group G₂₈ to the first sub-group G₂₁ in the respective subfields SF1 to SFL of the second row electrode group G₂, and the operation of the erase periods ER₂₁ to ER₂₈ is sequentially performed from the eighth sub-group G₂₈ to the first sub-group G₂₁ in the last subfield SFL of the second row electrode group G₂.

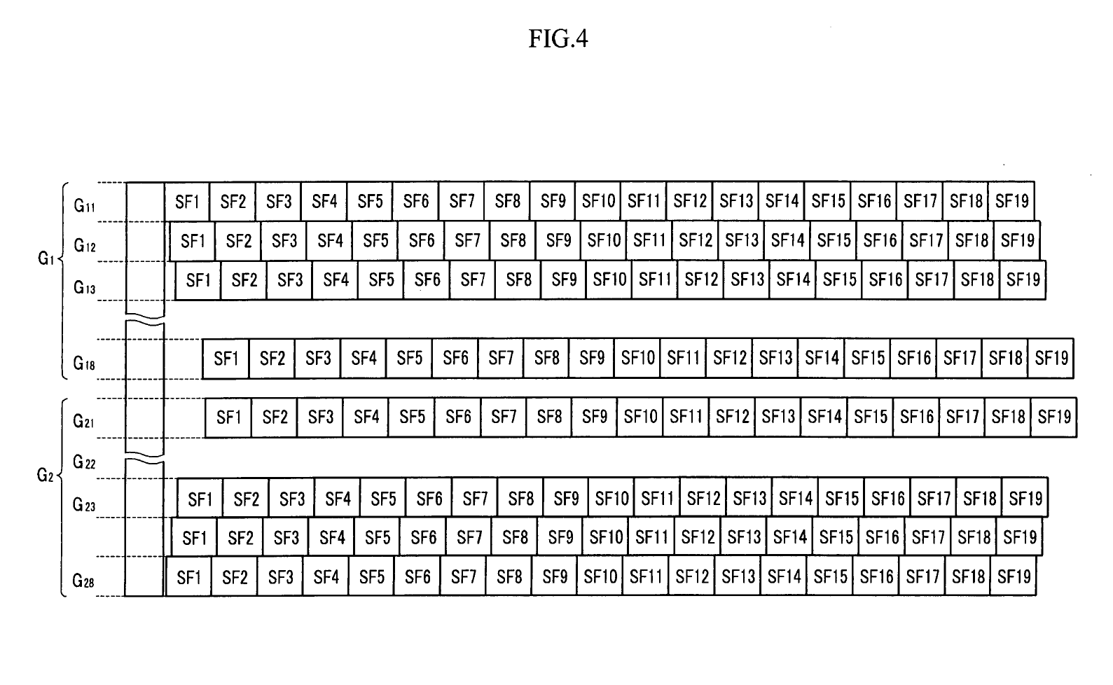

FIG. 4 is a diagram representing subfields to describe the driving method of FIG. 3. One subfield includes 19 subfields SF1 to SF19 in FIG. 4. As shown in FIG. 4, the plurality of subfields SF1 to SF19 forming one field are shifted by a predetermined interval in the respective sub-groups G₁₁ to G₁₈ and G₂₈ to G₂₁. In this case, the predetermined interval corresponds to a length of one address period EAi₁ᵢ or EAk₂ᵢ for one sub-group G₁ᵢ or G₂ᵢ and one sustain period Ski₁ᵢ or Sk₂ᵢ of one sub-group G₁ᵢ or G₂ᵢ. When it is assumed that the length of one sustain period Si₁ᵢ or G₂ᵢ for one sub-group G₁ᵢ or G₂ᵢ and the length of one address period EAk₁ᵢ or EAk₂ᵢ for one sub-group G₁ᵢ or G₂ᵢ are the same, a starting point of the respective subfields SF1 to SF19 of the second row electrode group G₂ is shifted by the length of the address period EAk₁ᵢ or EAk₂ᵢ from a starting point of the respective subfields SF1 to SF19 of the first row electrode group G₁.

Accordingly, the operation of the sustain period may be performed for the second row electrode group G₂ during the address period of the first row electrode group G₁, and the operation of the sustain period may be performed for the first row electrode group G₁ during the address period of the second row electrode group G₂. That is, since the operation of the sustain period can be performed during the address period without dividing the address period and the sustain period, the length of one subfield can be reduced.

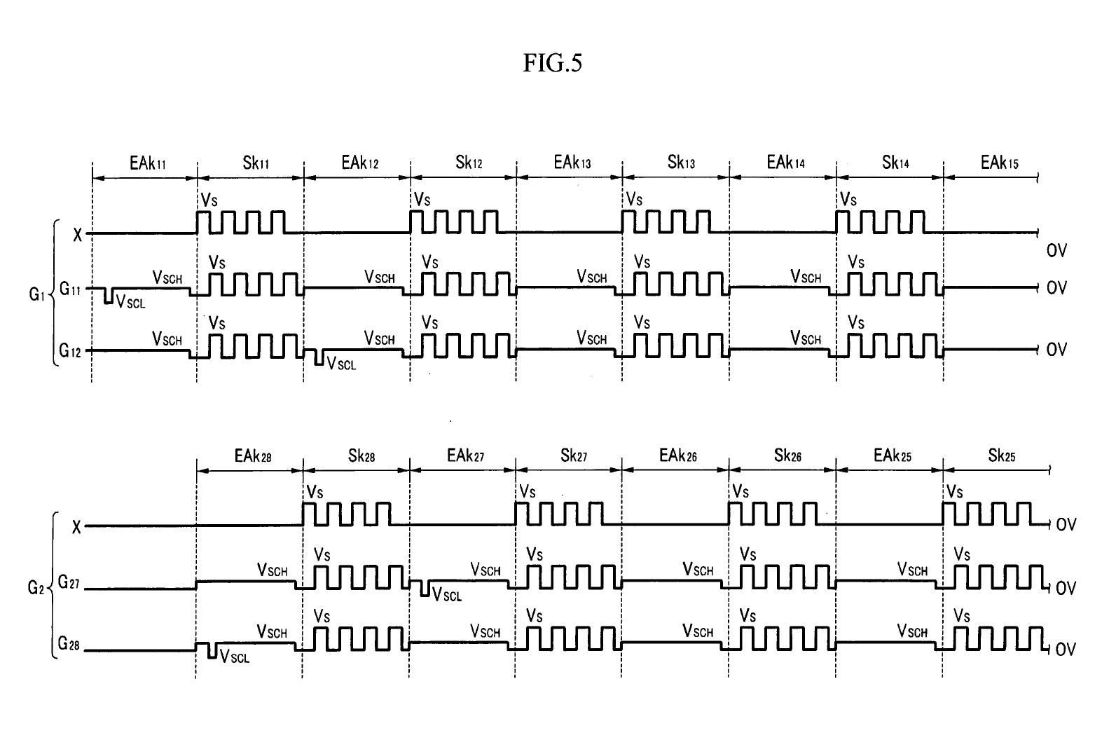

Driving waveforms of the method of driving the plasma display device according to the first exemplary embodiment of the present invention are described below with reference to FIG. 5.

FIG. 5 are views of driving waveforms of the method of driving the plasma display device of FIG. 3. For better understanding and ease of description, in FIG. 5, the first and second sub-groups G₁₁ and G₁₂ of the first row electrode group G₁ and the seventh and eighth sub-groups G₂₇ and G₂₈ of the second row electrode group G₂ in one subfield SFk are illustrated, and descriptions of driving waveforms supplied to the A electrode have been omitted.

As shown in FIG. 5, during the address period EAk₁₁ of the k^{th} subfield SFk in the first row electrode group G₁, while a reference voltage (0V voltage in FIG. 5) is supplied to the X electrode of the first row electrode group G₁, a scan pulse of a VscL voltage is sequentially supplied to a plurality of Y electrodes of the first sub-group G₁₁. In this case, an address pulse (not shown) having a positive voltage is supplied to the A electrode of cells to be selected as the non-light emitting cell from among the light emitting cells formed by the Y electrodes to which the scan pulse is supplied. A VscH voltage higher than the VscL voltage is supplied to the Y electrodes to which the scan pulse is not supplied, and the reference voltage is supplied to the A electrode to which the address pulse is supplied. Then, an erase discharge is generated in the light emitting cells to which the VscL voltage of the scan pulse and the positive voltage of the address pulse are supplied, wall charges formed in the X and Y electrodes are erased, and the cells thereof are set to be in the non-light emitting cell state.

As shown in FIG. 5, a sustain pulse has a high level voltage (Vs voltage in FIG. 5) and a low level voltage (0V voltage in FIG. 5), the sustain pulses of opposite phases are respectively supplied to the plurality of X electrodes of the first row electrode group G₁ and the Y electrode of the first to eighth sub-groups G₁₁ to G₁₈ during the sustain period Sk₁₁, and the light emitting cells of the first sub-group G₁₁ are sustain discharged. That is, a 0V voltage is supplied to the Y electrode when the Vs voltage is supplied to the X electrode, and the Vs voltage is supplied to the Y electrode when the 0V voltage is supplied to the X electrode. In this case, cells in which the erase discharge is not generated during the address period EAk₁₁, among the cells in the light emitting cell state in a previous subfield SF(k−1), are in the light emitting cell state, and the cells in the light emitting cell state are sustain discharged.

Subsequently, while the reference voltage is supplied to the X electrode of the first row electrode group G₁ during the address period EAk₁₂ of the second sub-group G₁₂), the scan pulse of the VscL is sequentially supplied to the plurality of Y electrodes of the second sub-group G₁₂, and the address pulse (not shown) having the positive voltage is supplied to the A electrodes of the cells to be selected as the non-light emitting cells among the light emitting cells formed by the Y electrodes to which the scan pulse is supplied.

During the sustain period Sk₁₂, the sustain pulses of the opposite phases are supplied to the plurality of X electrodes of the first row electrode group G₁ and the Y electrode of the first to the eighth sub-group G₁₁ to G₁₈, and the light emitting cells are sustain discharged. In a like manner, the operations of the address periods EAk₁₃ to EAk₁₈ and the sustain periods Sk₁₃ to Sk₁₈ are performed for the remaining sub-groups G₁₃ to G₁₄.

Subsequently, while the operation of the sustain period Sk₁₁ of the first sub-group G₁₁ of the k^{th} subfield SFk is performed in the first row electrode group G₁, the operation of the address period EAk₂₈ of the eighth sub-group G₂₈ of the k^{th} subfield SFk is performed in the second row electrode group G₂. While the reference voltage is supplied to the X electrode during the address period EAk₂₈ of the k^{th} subfield SFk of the second row electrode group G₂, the scan pulse of the VscL is sequentially supplied to the plurality of Y electrodes of the eighth sub-group G₂₈, and the address pulse (not shown) having the positive voltage is supplied to the A electrodes selected as the non-light emitting cell among the light emitting cells formed by the Y electrodes to which the scan pulse is supplied.

Then, the sustain pulses of the opposite phases are supplied to the plurality of X electrodes of the second row electrode group G₂ and the Y electrode of the first to eighth sub-groups G₂₁ to G₂₈ during the sustain period Sk₂₈, and the light emitting cells are sustain discharged. In addition, while the operation of the sustain period Sk₂₈ of the k^{th} subfield SFk of the second row electrode group G₂ is performed, the operation of the address period EAk₁₂ of the second sub-group G₁₂ of the k^{th} subfield SFk is performed in the first row electrode group G₁. In a like manner, the operations of the address periods EAk₂₇ to EAk₂₁ and the sustain periods Sk₂₇ to Sk₂₁ are performed for the remaining sub-groups G₂₇ to G₂₁.

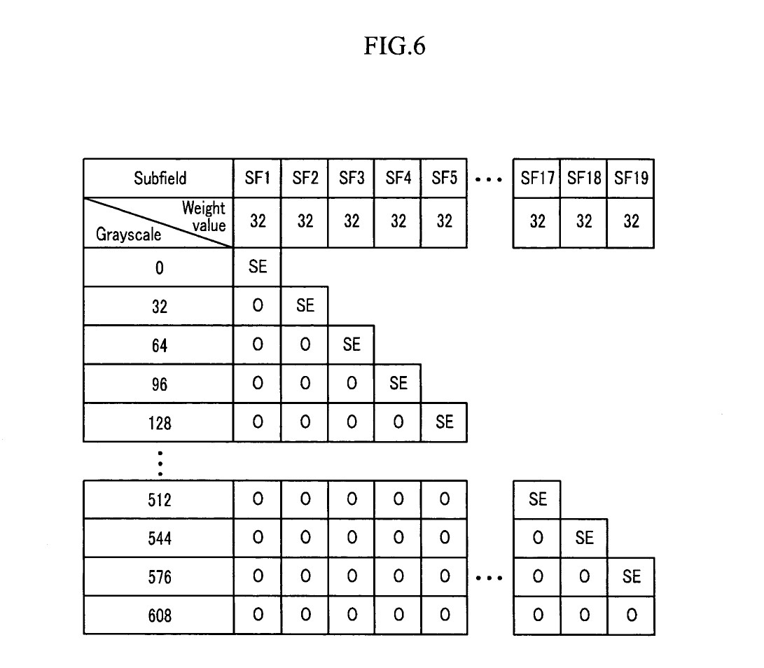

FIG. 6 is a diagram of a method of expressing grayscales in the driving method of FIG. 3 according to a first exemplary embodiment of the present invention. In FIG. 6, one field includes 19 subfields, and weight values of the respective subfields are 32. In addition, SE denotes a cell set to be in the non-light emitting cell state from the light emitting cell state after generating the erase discharge in a corresponding subfield, and ◯ denotes a cell in a light emitting cell state in a corresponding subfield.

As shown in FIG. 6, when the erase discharge is generated and the cell in the light emitting cell state becomes the cell in the non-light emitting cell state during the address period of the first subfield SF1, the sustain discharge is not generated during the sustain period, the sustain discharge is not generated in subsequent subfields SF2 to SFL, and therefore 0 grayscales are expressed. When the erase discharge is generated during the address period of the second subfield SF2 and the cell in the light emitting cell state becomes the cell in the non-light emitting cell state, the sustain discharge is not generated from the second subfield SF2 to the nineteenth subfield SF19, and therefore 32 grayscales are expressed. When the erase discharge is not generated during the address period of the second subfield SF2, the erase discharge is generated during the address period of the third subfield SF3, and the cell in the light emitting cell state becomes the cell in the non-light emitting cell state, 64 grayscales are expressed. That is, since the sustain discharge is continuously generated on the discharge cell in the light emitting cell state in the first subfield to (k−1)^{th} subfields when the erase discharge is generated in the k^{th} subfield and the cell in the light emitting cell state becomes the cell in the non-light emitting cell state, 32×(K−1) grayscales are finally expressed. That is, grayscales corresponding to a multiple of 32 can be expressed from among the 0 grayscales to 628 (=32×19) grayscales. In addition, grayscales that do not correspond to the multiple of 32 can be expressed in a dithering method. In the dithering method, predetermined grayscales are combined to express grayscales that are close to desired grayscales within a predetermined area. Accordingly, grayscales between the 0 grayscales and the 32 grayscales can be expressed in the predetermined area by using the 0 grayscales and the 32 grayscales.

In the first subfield SF1, the discharge cells of the respective sub-groups G₁₁ to G₁₈ and G₂₁ to G₂₈ are in the light emitting cell state before the operation of the address period of a corresponding sub-group is performed. Then, an unnecessary sustain discharge is generated on the discharge cells in the i^{th} sub-group of the first group G₁ during sustain periods S1₁₁, to S1₁₍ᵢ₋₁₎ before the operation of the address period EA₁ᵢ is performed (here, i is an integer between 2 and 8). Accordingly, in the first exemplary embodiment of the present invention, the i^{th} sub-group G₁ᵢ can be set in a state in which the sustain discharge is not generated during the sustain periods S1₁₁ to S1₁₍ᵢ₋₁₎ of the first to (i−1)^{th} sub-groups G₁₁ to G₁₍ᵢ₋₁₎ in the first subfield. In a like manner, the discharge cells of the (8−(i−1))^{th} sub-group G₂(8−(i−1)) of the second group G₂ can be set to be in a state in which the sustain discharge is not generated during the sustain period S1₂₈ to S1_{2 (8-(i-2)} of the eighth to (8−(i−2))^{th} sub-groups G₂₈ to G₂ (8−(i−2).

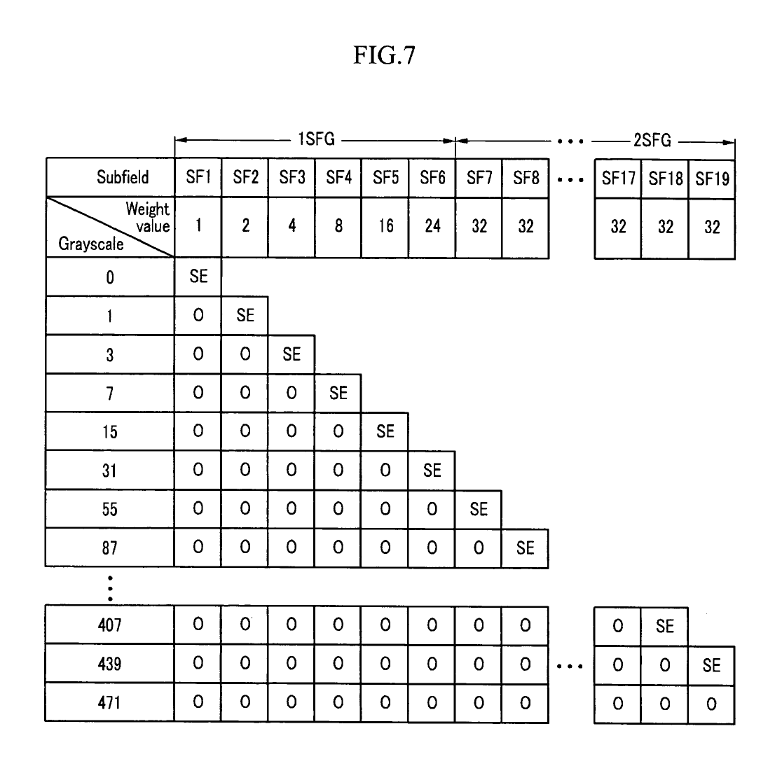

As described, in the first exemplary embodiment of the present invention, since grayscales are expressed by subsequent subfields before the erase discharge is generated in a corresponding subfield among the plurality of subfields SF1 to SF19 and the discharge cell in the light emitting cell state becomes the discharge cell in the non-light emitting cell state, a false contour is not generated. In addition, since the sustain discharge is continuously generated on the discharge cell set to be in the light emitting cell state during the reset period R before the erase discharge is generated and the discharge cell is set to be in the non-light emitting cell state in the respective subfields SF1 to SF19, the discharge is generated once when any grayscales are expressed. Accordingly, power consumption caused by the erase discharge is reduced. However, when the dithering is used to express low grayscales rather than using a combination of subfields, a low grayscale expression can be reduced. That is, since people can perceive a grayscale difference at low grayscales better than a grayscale difference at high grayscales, the low grayscale expression can be reduced when the low grayscales are expressed in the dithering method rather than using the combination of subfields. A method of increasing the low grayscale expression is described below with reference to FIG. 7.

FIG. 7 is a diagram of a method of expressing grayscales in the driving method of FIG. 3 according to a second exemplary embodiment of the present invention.

As shown in FIG. 7, the subfields SF1 to SFL are grouped into a first subfield group and a second subfield group. In addition, weight values of the subfields SF1, SF2, SF3, SF4, SF5, and SF6 of the first subfield group are respectively set to be 1, 2, 4, 8, 16, and 24 in order to increase performance for expressing the low grayscales. Accordingly, among the low grayscales expressed in the dithering method in FIG. 6, 1, 3, 7, 15, 31, and 55 grayscales can be exactly expressed by combinations of the subfields SF1 to SF6 of the first subfield group. Furthermore, when the dithering method is used for the grayscales, the expression between the 1 and 55 grayscales can be increased as compared to the first exemplary embodiment of the present invention.

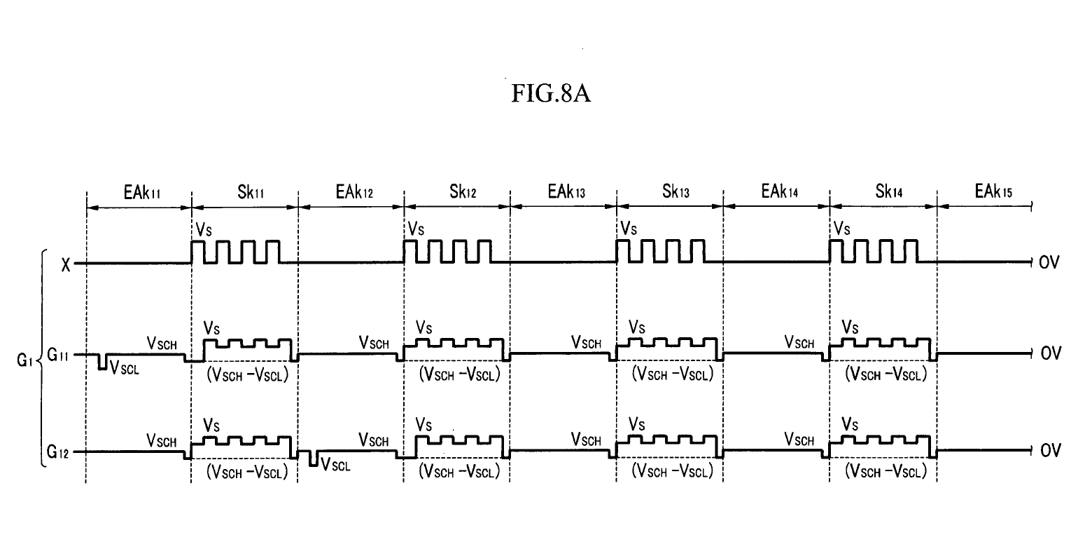

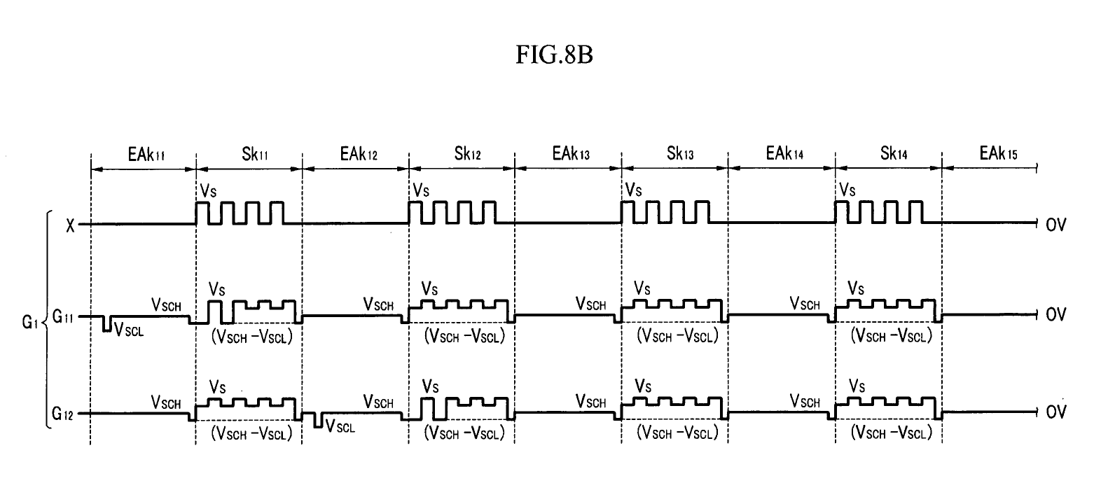

A method of realizing weight values of the subfields SF1 to SF6 of the first group is described below with reference to FIG. 8A and FIG. 8B.

FIG. 8A and FIG. 8B are respective waveform diagrams of realized weight values of the subfields SF1 to SF6 of the first group. In FIG. 8A and FIG. 8B, for better understanding and ease of description, the first and second sub-groups G₁₁ and G₁₂ of the first row electrode group G₁ are illustrated.

When the first and second row electrode groups G₁ are G₂ respectively divided into eight sub-groups G₁₁ to G₁₈ and G₂₁ to G₂₈, weight values of the respective subfields SF1 to SFL correspond to sums of lengths of the eight sustain periods of the respective subfields SF1 to SFL. For example, when the weight value of the subfield SFk shown in FIG. 5 is 32, the lengths of the respective sustain periods Sk₁₁ to Sk₁₈ and Sk₂₁ to Sk₂₈ in the subfield SFk are a weight value of 4. In addition, the four sustain pulses are respectively supplied to the X and Y electrodes during the respective sustain periods Sk₁₁ to Sk₁₈ and Sk₂₁ to Sk₂₈.

Accordingly, a weight value of 1 corresponds to a ¼ length of the sustain period Sk₁ⱼ of the respective sub-groups G₁₁ to G₁₈ or G₂₁ to G₂₈ of one row electrode group G₁ or G₂ (here, j is an integer between 1 and 8). As shown in FIG. 8A, in the k subfield SFk of the first row electrode group G₁, when the Vs voltage of the sustain pulse is supplied to the X electrode after one sustain pulse is supplied to the Y electrode of the first sub-group G₁₁ during the sustain period Sk₁₁ of the first sub-group G₁₁, a (VscH−VscL) voltage corresponding to a difference to between the VscH voltage and the VscL voltage is supplied to the Y electrode as a low level voltage of the sustain pulse. In addition, during the remaining sustain periods Sk₁₂ to Sk₁₈ of the first sub-group G₁₁, when the Vs voltage of the sustain pulse is supplied to the X electrode, the (VscH−VscL) voltage is supplied to the Y electrode of the first sub-group G₁₁ as the low level voltage of the sustain pulse. When the Vs voltage of the sustain pulse is supplied to the X electrode after one sustain pulse is supplied to the Y electrode of the second sub-group G₁₂ during the sustain period Sk₁₂ of the second sub-group G₁₂, the (VscH−VscL) voltage corresponding to the difference between the VscH voltage and the VscL voltage is supplied to the Y electrode of the second sub-group G₁₂ as the low level voltage of the sustain pulse. In addition, the (VscH−VscL) voltage is supplied to the Y electrode of the second sub-group G₁₂ as the low level voltage of the sustain pulse during the remaining sustain periods Sk₁₃ to Sk₁₈ of the second sub-group G₁₂ and the sustain period S(k+1)₁₁ of the first sub-group G₁₁ of the (k+1)^{th} subfield SF(k+1).

In the second exemplary embodiment of the present invention, since the subfield SF1 having the weight value of 1 is subsequently provided after the reset period R, the respective sub-groups G₁ᵢ or G₂ (8−(i−1)) are set such that the sustain discharge is not generated during the sustain periods S₁₁ to S₁₍ᵢ₋₁₎ or S₂₈ to S₂₍₈₋₍ᵢ₋₂₎ before the corresponding address period EA₁ᵢ or EA_{2 (8-(i-1)}. Accordingly, the (VscH−VscL) voltage can be supplied to the Y electrodes of the respective sub-groups G₁ᵢ or G₂₍₈₋₍ᵢ₋₁₎₎ as the low level voltage during the sustain periods S₁₁-S₁₍ᵢ₋₁₎ or S₂₈-S_{2 (8-(i-2)} before the corresponding address period EA₁ᵢ or EA_{2 (8-(i-1)}. That is, as shown in FIG. 8A, since the plurality of discharge cells are set to be in the light emitting cell state during the reset period R of the second sub-group G₁₂, the sustain discharge is generated when the sustain pulse having the Vs voltage and 0V voltage is supplied to the Y electrode of the second to eighth sub-groups G₁₂ to G₁₈ during the sustain period Sk₁₁ of the first sub-group G₁₁. Therefore, the (VscH−VscL) voltage is supplied to the Y electrode of the second to eighth sub-groups G₁₂ to G₁₈ during the sustain period Sk₁₁ of the first sub-group G₁₁. In this case, a difference between the Vs voltage and the (VscH−VscL) voltage is a voltage that is not enough to generate the sustain discharge between the X and Y electrodes. Then, when the (VscH−VscL) voltage is supplied to the Y electrode as the low level voltage of the sustain pulse, the sustain discharge is not generated between the X and Y electrodes. When the sustain discharge is not generated between the X and Y electrodes when the Vs voltage is supplied to the X electrode, a wall potential of the X electrode is maintained to be greater than the wall potential of the Y electrode, and therefore the sustain discharge is not generated when the Vs voltage is supplied to the Y electrode and the OV voltage is supplied to the X electrode. Accordingly, the subfield having the weight value of 1 can be realized. In addition, the second row electrode group G₂ is substantially equivalent to the first row electrode group G₁. That is, after one sustain pulse is respectively supplied to the X and Y electrodes during the sustain period Sk₂₈ of the eighth sub-group G₂₈ of the second row electrode group G₂, the (VscH−VscL) voltage is supplied to the Y electrode as the low level voltage of the sustain pulse when the Vs voltage of the sustain pulse is supplied to the X electrode. In this case, the (VscH−VscL) voltage is supplied as the low level voltage of the sustain pulse to the Y electrode of the seventh to first sub-groups G₂₇ to G₂₁ of the second row electrode group. In addition, during the remaining sustain periods Sk₂₇ to Sk₂₁, when the Vs voltage of the sustain pulse is supplied to the X electrode, the (VscL−VscH) voltage is supplied to the Y electrode as the low level voltage of the sustain pulse. In a like manner as above, the sustain discharge is generated in the light emitting cells of the seventh to first sub-groups G₂₇ to G₂₁. The weight values are described below with respect to the first sub-group G₁₁ of the first row electrode group G₁.

Since the weight value of 2 corresponds to a 2/1 length of one sustain period Sk₁ⱼ among the sustain periods of the respective sub-groups G₁₁ to G₁₈ or G₂₁ to G₂₈ of one row electrode group G₁ or G₂, two sustain pulses are respectively supplied to the X and Y electrodes during the sustain period Sk₁, of the first sub-group G₁₁ as shown in FIG. 8B, and then the (VscH−VscL) voltage is supplied to the Y electrode as the low level voltage of the sustain pulse when the Vs voltage of the sustain pulse is supplied to the X electrode. In addition, during the remaining sustain periods Sk₁₂ to Sk₁₈ of the first sub-group G₁₁, the (VscH−VscL) voltage is supplied to the Y electrode as the low level voltage of the sustain pulse when the Vs voltage of the sustain pulse is supplied to the X electrode. In this case, the (VscH−VscL) voltage is supplied to the Y electrode of the second to eighth sub-groups G₁₂ to G₁₈ as the low level voltage of the sustain pulse. Accordingly, the subfield having the weight value of 2 can be realized.

The weight value of 4 can be realized when four sustain pulses are respectively supplied to the X and Y electrodes during the sustain period Sk₁₁ of the first sub-group G₁₁, the Vs voltage of the sustain pulse is supplied to the X electrode during the remaining sustain periods Sk₁₂ to Sk₁₈ of the first sub-group G₁₁, and the (VscH−VscL) voltage is supplied to the Y electrode as the low level voltage of the sustain pulse. In addition, the weight value of 8 can be realized when the four sustain pulses are respectively supplied to the X and Y electrodes during the sustain periods Sk₁₁ and Sk₁₂ of the first sub-group G₁₁, the (VscH−VscL) voltage is supplied to the Y electrode as the low level voltage of the sustain pulse during the sustain periods Sk₁₃ to Sk₁₈.

The sustain discharge is generated during all the sub-groups G₁₁ to G₁₈ of the first row electrode group G₁ when the weight value of the subfield SFk shown in FIG. 5 is 32 and an operation of the address period of one sub-group among the second row electrode group G₂ occurs. When the operation of the address period of the first sub-group G₂₁ of the second row electrode group G₂ is performed, the weight value of 24 can be realized in a subfield in which the sustain discharge is generated in six sub- groups G₁₁ to G₁₆ among the sub-groups G₁₁ to G₁₈ of the first row electrode group G₁, and the weight value of 16 may be realized in a subfield in which the sustain discharge is generated in four sub-groups G₁₁ to G₁₄. The weight value of 8 can be realized in a subfield in which the sustain discharge is generated in two sub-groups G₁₁ and G₁₂. The weight value of 4 can be realized in a subfield in which the sustain discharge is generated in one sub-group G₁₁. A weight value lower than 4 can be realized in a subfield in which the sustain discharge is generated in a part of the sustain period of one sub-group G₁₁.

While it is illustrated that the (VscH−VscL) voltage is supplied as the low level voltage of the sustain pulse so that the sustain discharge cannot be generated in the X and Y electrode in FIG. 8A and FIG. 8B, the Y electrode can be floated. Since the voltage at the Y electrode varies according to the voltage at the X electrode when the Y electrode is floated, a voltage difference between the X and Y electrodes, and the sustain discharge is not generated in the light emitting cell. In addition, the high level voltage Vs or the low level voltage 0V can be continuously supplied to one of the X and Y electrodes.

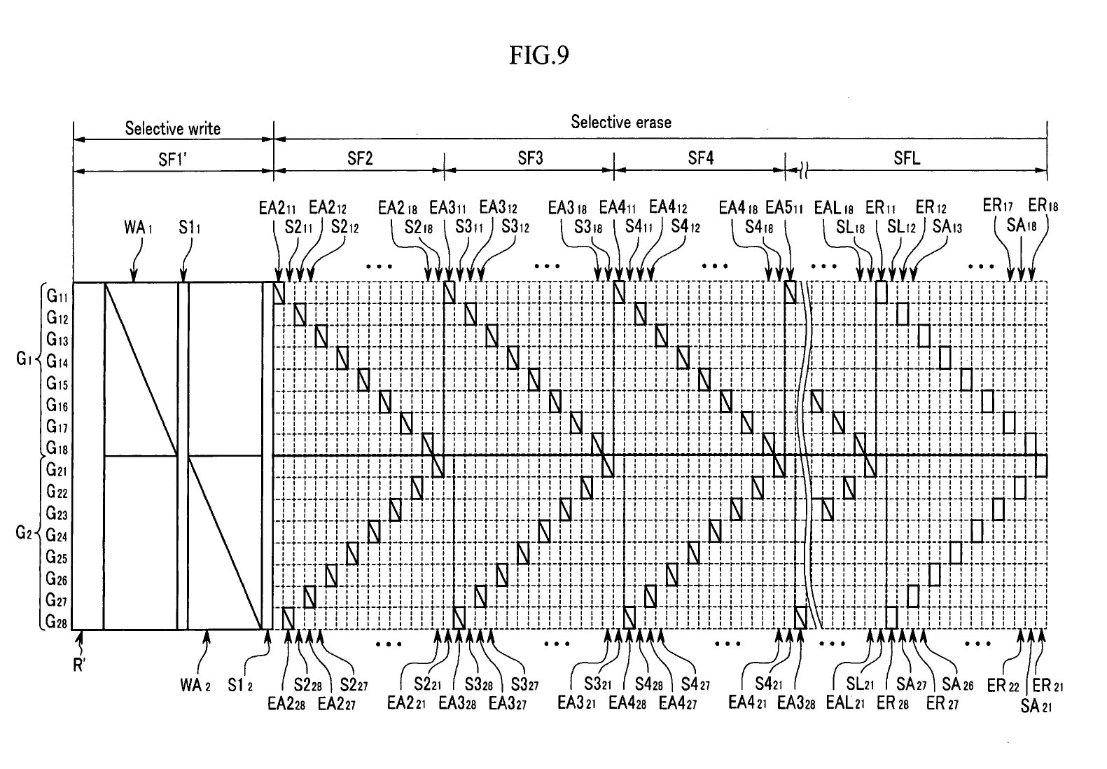

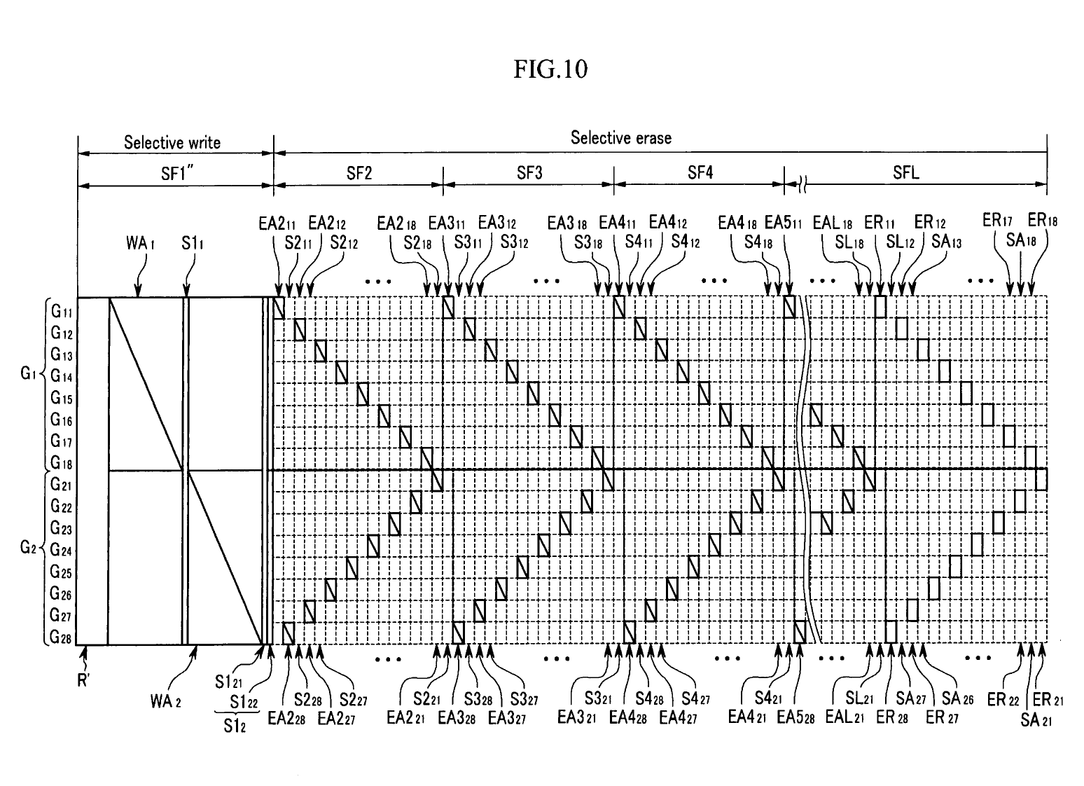

In the driving method according to the first exemplary embodiment of the present invention, to initialize all the discharge cells to be in the light emitting cell state during the reset period R before the address period of the first subfield SF1, it is necessary to generate a strong discharge for the reset discharge. In this case, however, a contrast ratio can be problematically reduced since a black screen becomes too bright. In addition, it is difficult to form the wall charges that are sufficient to set all the discharge cells to be in the light emitting cell state only by the reset period R. A method of increasing the contrast ratio and stably generating the erase discharge is described below with reference to FIG. 9 and FIG. 10.

FIG. 9 and FIG. 10 are respective methods of driving the plasma display device according to third and fourth exemplary embodiments of the present invention.

As shown in FIG. 9, the driving method according to the third exemplary embodiment of the present invention is similar to that of the first exemplary embodiment of the present invention. However, differing from the first exemplary embodiment of the present invention, the selective write method is used for address periods WA1₁ and WA1₂ of a first subfield SF1′ in the third exemplary embodiment of the present invention. In the first subfield SF1′, a plurality of row electrodes are not grouped into sub-groups in the respective row electrode groups G₁ and G₂, and a light emitting cell is respectively selected from among discharge cells formed by the lurality of row electrodes during one address period WA1₁ and WA1₂. Accordingly, in the subfield SF1′ having the address periods WA1₁ and WA1₂ in the selective write method, a reset period R′ for initializing the light emitting cell to be the non-light emitting cell is formed before the address periods WA1₁ and WA1₂. That is, while the discharge cell is initialized to be in the light emitting cell state during the reset period R before the address periods EA1₁₁ to EAL₁₈ and EA1₂₁ to EAL₂₈ in the selective erase method according to the first exemplary embodiment of the present invention, the light emitting cell is initialized to be in the non-light emitting cell state during the reset period R′ before the address periods WA1₁ and WA1₂ in the selective write method.

In more detail, the discharge cells in the first and second row electrode groups G₁ and G₂ are initialized to be in the non-light emitting cell state during the reset period R′ of the first subfield SF1′, and are set to a state for performing a write discharge during the address periods WA1₁ and WA1₂. The discharge cells to be the light emitting cell among the discharge cells of the first row electrode group G₁ are write-discharged to form wall charges during the address period WA1₁, and the light emitting cell of the first row electrode group G₁ is sustain-discharged during the sustain period S1₁. Subsequently, the wall charges formed in the light emitting cell II of the first row electrode group G₁ are erased. Then, the light emitting cell of the first row electrode group G₁ is light-emitted during the sustain period S2₁₁ of the first row electrode group G₁.

The discharge cell to be in the light emitting cell state among the discharge cells of the second row electrode group is write-discharged to form the wall charges during the address period WA1₂, the light emitting cell of the second row electrode group G₁₂ is sustain-discharged during the sustain period S1₂, and the wall charges formed in the light emitting cell of the second row electrode group G₂ are erased.

As described, according to the third exemplary embodiment of the present invention, the plurality of row electrodes of the first and second row electrode groups G₁ and G₂ are sequentially write-discharged during the address periods WA1₁ and WA1₂ to select the light emitting cell, and the operations of the sustain periods S1₁ and S1₂ are performed to generate the sustain discharge. Accordingly, the wall charges can be sufficiently formed on the respective electrodes of the light emitting cell before the operations of the subfields SF2 to SFL respectively having the address period in the selective erase method are performed.

In addition, to erase the wall charges formed on the light emitting cell of the respective groups G₁ and G₂ after the sustain periods S1₁ and S1₂ of the respective groups G₁ and G₂ in the first subfield SF1′, a last pulse width of the sustain pulse is narrowly formed during the sustain periods S1₁ and S1₂ of the respective groups G₁ and G₂ so that the wall charges cannot be formed. The wall charges formed by the sustain discharge can be erased by using a waveform (e.g., a waveform varying in a ramp pattern) for gradually changing a voltage at the row electrode after the last sustain pulse.

In addition, to initialize the discharge cell to be in the non-light emitting cell state during the reset period R′ before the address periods WA1₁ to WA1₂ in the selective write method, the reset period can be realized by using gradually increasing and decreasing voltages. That is, voltages at the plurality of Y electrodes are gradually increased, and the voltages at the plurality of Y electrodes are gradually decreased during the reset period R′. In other words, after the wall charges are formed on the discharge cell when a weak reset discharge is generated between the Y and X electrodes while the voltage at the Y electrode increases, the wall charges formed on the discharge cell can be erased and initialized to be in the non-light emitting cell state when the weak reset discharge is generated between the Y and X electrodes while the voltage at the Y electrode is decreased. Accordingly, a contrast ratio can be increased since a strong discharge is not generated during the reset period R1.

However, in a like manner of the second exemplary embodiment of the present invention shown in FIG. 9, the erase operation for erasing the wall charges formed on the discharge cell of the respective row electrode groups G₁ and G₂ cannot be performed after the sustain periods S1₁ and S1₂ of the respective row electrode groups G₁ and G₂.

In more detail, as shown in FIG. 10, the discharge cell to be in the light emitting cell 5 state among the discharge cells of the first row electrode group G₁ are write-discharged to form the wall charge during the address period WA1₁ of a first subfield SF″, and the light emitting cell of the first row electrode group G₁ is sustain-discharged during the sustain period S1₁. In this case, during the sustain period S1₁, the sustain discharge is set to be generated the minimum number of times (e.g., once or twice).

Subsequently, the discharge cell to be in the light emitting cell state among the discharge cells of the second row electrode group G₂ is write discharged during the address period WA1₂ of the first subfield SF1″ to form the wall charges, and the light emitting cells of first and second row electrode groups G₁ and G₂ are sustain-discharged during a partial period S1₂₁ among the sustain period S1₂. In addition, while the light emitting cell of the first row electrode group G₁ is set so that the sustain discharge cannot be generated during a partial period S1₂₂ among the sustain period S1₂, the light emitting cell of the second row electrode group G₂ is sustain discharged and the light emitting cell of the first row electrode group G₁ is not sustain discharged. In this case, the number of sustain discharges generated in the light emitting cell of the second row electrode group G₂) during the partial period S1₂₂ among the sustain period S1₂ is set to be equal to the number of sustain discharges generated in the light emitting cell of the first row electrode group G0 during the sustain period S1₂.

Furthermore, when the two sustain periods S1₁ and S1₂ do not satisfy the weight value of the first subfield SF1″, the light emitting cell of the first and second row electrode groups G₁ and G₂ can be additionally sustain-discharged during the partial period S1₂₂ among the sustain period S1₂.

While the erase periods ER1₁₂ to ER1₁₈ and ER1₂₂ to ER1₂₈ and the additional sustain periods SA₁₂ to SA₁₈ and SA₂₂ to SA₂₈ of the first and second row electrode groups G₁ and G₂ are formed in the last subfield SFL of one field according to the first to third exemplary embodiments of the present invention, those can be omitted. When the erase periods ER1₁₂ to ER1₁₈ and ER1₂₂ to ER1₂₈ and the additional sustain periods SA₁₂ to SA₁₈ and SA₂₂ to SA₂₈ are omitted, an order for addressing the respective sub-groups G₁₁ to G₁₈ and G₂₁ to G₂₈ in the respective row electrode groups through a plurality of fields is changed. Then, the number of sustain discharges in the respective row electrode groups can become the same.

According to a fourth exemplary embodiment of the present invention, when it is assumed that the scan pulse width is 0.7 μs, one sustain period includes eight sustain pulses, a time for supplying one sustain pulse (the pulse having the high level voltage and the low level voltage) is 5.6 μs, and 1024 row electrodes are driven in the selective erase method, the length of the sustain period is 44.8 μs (=5.6 μs×8) and the length of the address period is 44.8 μs (=0.7 μs×64 rows). Accordingly, the length of one subfield is 716.8 μs (=44.8 μs×16). When the selective write method uses the scan pulse having the width of 1.3 μs and the reset period having the length of 350 μs, the length of the address period is 665.6 μs (=1.3 μs×512 rows). In this case, when the weight value is 1, one sustain pulse is supplied during the sustain period S1₁, and one and a half sustain pulses are supplied during the sustain period S1₂, the length of sustain periods (S1₁+S1₂) is 14 μs (=5.6 μs×2.5). Accordingly, the length of the subfield SF1 is 1695.2 μs (=350 μs+665.6 μs×2+14 μs).

That is, since a time supplied to the subfield of the selective erase method in one field is 14970.8 μs (=16666-1695.2) according to the fourth exemplary embodiment of the present invention, 20 (=14970.8/716.8) subfields of the selective erase method may be used in one field.

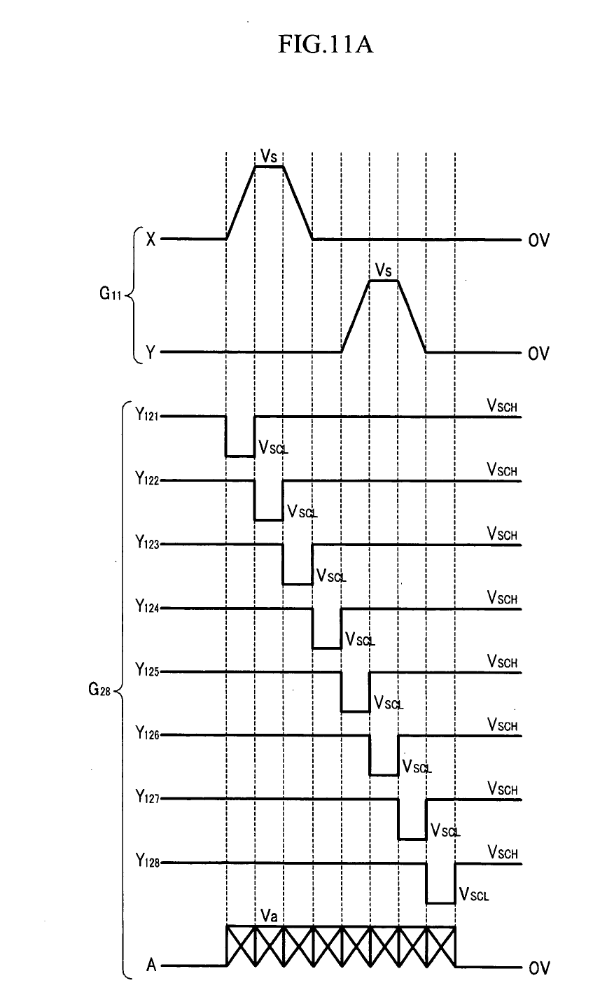

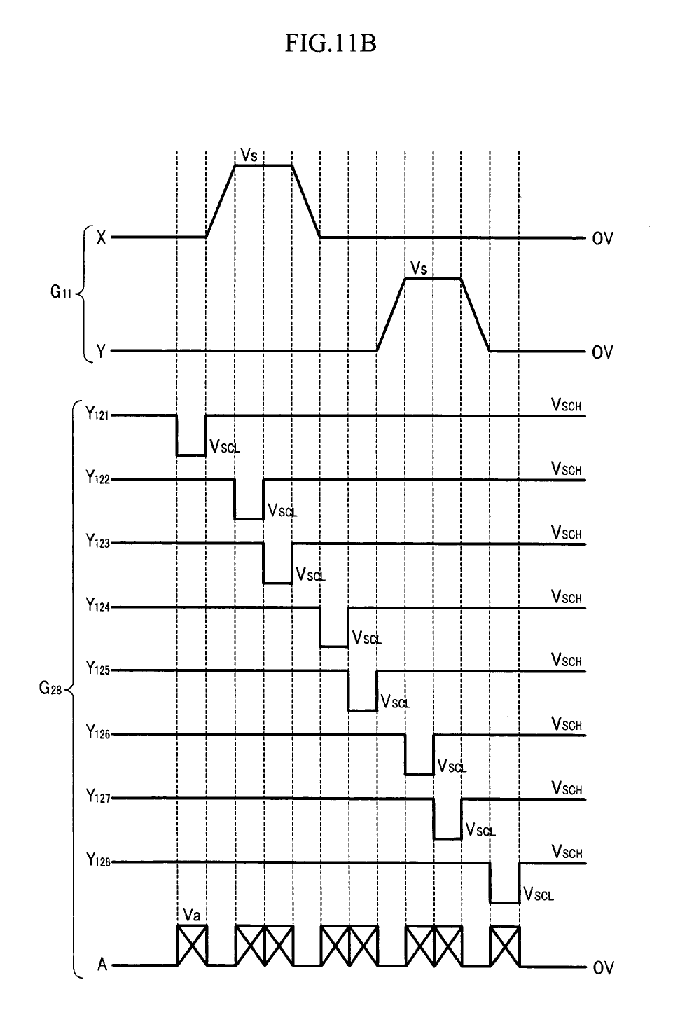

An address pulse supplied to the A electrode and a scan pulse supplied to the Y electrode will now be described with reference to FIG. 11A and FIG. 11B.

FIG. 11A and FIG. 11B are waveform diagrams of the plasma display device according to a fifth exemplary embodiment of the present invention. In FIG. 11A, for better understanding and ease of description, a part of the sustain period Sk₁₁ of the first sub-group G₁₁ of the first row electrode group G₁ in a k^{th} subfield SFk is illustrated, and the numbers of X and Y electrodes are respectively 128 lines. Accordingly, the sub-groups respectively include eight Y electrodes.

As shown in FIG. 11A, the sustain period Sk₁₁ of the first sub-group G₁₁ of the first row electrode group G₁ corresponds to the address period EAk₂₈ of the eighth sub-group G₂₈ of the second row electrode group G₂. Accordingly, while the sustain pulse is alternately supplied to the X electrode and the Y electrodes Y₁-Y₈ of the first sub-group G₁₁ of the first row electrode group G₁, a scan pulse VSCL is sequentially supplied to the Y electrodes Y₁₂₁ to Y₁₂₈ of the eighth sub-group G₂₈ of the second row electrode group G₂, and an address pulse Va is supplied to the A electrode of the eighth sub-group G₂₈ of the second row electrode group G₂. Until the sustain period Sk₁₁ is finished after the scan pulse is supplied to all the Y electrodes Y₁₂₁ to Y₁₂₈ of the eighth sub-group G₂₈ of the second row electrode group G₂, the voltage at the Y electrodes Y₁₂₁ to Y₁₂₈ is maintained at the high level voltage V_{SCH} of the scan pulse, and the voltage at the electrode is maintained at the reference voltage (0V in FIG. 11A). In addition, while it is not described in FIG. 11A, the reference voltage is supplied to the X electrode of the eighth sub-group G₂₈ of the second row electrode group G₂.

In this case, when the sustain pulse supplied to the X or Y electrode of the first sub-group G₁₁ of the first row electrode group G₁ is increased or decreased, the address pulse may be supplied to the A electrode of the eighth sub-group G₂₈ of the second row electrode group G₂. As shown in FIG. 11A, the scan pulse is supplied to the Y electrode Y₁₂₁ of the eighth sub-group G₂₈ of the second row electrode group G₂ and the address pulse Va is supplied to the A electrode while the sustain pulse supplied to the X electrode of first sub-group G₁₁ of the first row electrode group G₁ is increased, and the scan pulse is supplied to the Y electrode Y₁₂₃ and the address pulse Va is supplied to the A electrode while the sustain pulse is decreased. In a like manner, the scan pulse is supplied to the Y electrode Y₁₂₅ of the eighth sub-group G₂₈ of the second row electrode group G₂ and the address pulse Va is supplied to the A electrode while the sustain pulse supplied to the Y electrode of the first sub-group G₁₁ of the first row electrode group G₁ is increased, and the scan pulse is supplied to the Y electrode Y₁₂₇ and the address pulse Va is supplied to the A electrode while the sustain pulse is decreased.

Accordingly, momentary inrush currents may flow into an X electrode or a Y electrode driver of the first sub-group G₁₁ of the first row electrode group G₁ and an A electrode driver of the eighth sub-group G₂₈ of the second row electrode group G₂, and therefore ElectroMagnetic Interference (EMI) can occur. In a like manner, when the address pulse is supplied to the A electrode of the first row electrode group G₁ when the sustain pulse supplied to the X electrode or the Y electrode of the second row electrode group G₂ is increased or decreased, EMI can occur.

Accordingly, driving waveforms for reducing the EMI in the plasma display device according to a sixth exemplary embodiment of the present invention will be described with reference to FIG. 11B.

FIG. 11A and FIG. 11B are waveform diagrams of the plasma display device according to a fifth exemplary embodiment of the present invention. In FIG. 11B, for better understanding and ease of description, a part of the sustain period Sk₁₁ of the first sub-group G₁₁ of the first row electrode group G₁ in the k^{th} subfield SFk is illustrated.

According to the sixth exemplary embodiment of the present invention, the address pulse is not supplied to the A electrode of the eighth sub-group G₂₈ of the second row electrode group G₂ while the sustain pulse supplied to the X electrode or the Y electrode of the first sub-group G₁₁ of the first row electrode group G₁ is increased or decreased. That is, between the sustain pulses supplied to the X electrode or the Y electrode of the first sub-group G₁₁ of the first row electrode group G₁, or while the sustain discharge voltage of the sustain pulse is maintained, the address pulse is supplied to the A electrode of the eighth sub-group G₂₈ of the second row electrode group G₂.

In more detail, as shown in FIG. 11B, the address pulse Va is supplied to the A electrode while the scan pulse is supplied to the Y electrode Y₁₂₁ of the eighth sub-group G₂₈ of the second row electrode group G₂ before the sustain pulse is supplied to the X electrode of the first sub-group G₁₁ of the first row electrode group G₁, and, while the sustain pulse supplied to the X electrode of the first sub-group G₁₁ of the first row electrode group G₁ is increased from 0V to the Vs voltage, the scan pulse is not supplied to the Y electrode of the eighth sub-group G₂₈ of the second row electrode group G₂ and the address pulse Va is not supplied to the A electrode. The scan pulse is sequentially supplied to the Y electrodes Y₁₂₂ to Y₁₂₃ of the eighth sub-group G₂₈ of the second row electrode group G₂ and the address pulse Va is supplied to the A electrode while the sustain pulse is maintained at the Vs voltage, and the scan pulse is not supplied to the Y electrode of the eighth sub-group G₂₈ of the second row electrode group G₂ and the address pulse Va is not supplied to the A electrode while the sustain pulse is decreased from the Vs voltage to 0V.

In a like manner, the scan pulse is supplied to the Y electrodes Y₁₂₄ and Y₁₂₅ of the eighth sub-group G₂₈ of the second row electrode group G₂ and the A electrode is supplied to the A electrode before the sustain pulse is supplied to the X electrode of the first sub-group G₁₁ of the first row electrode group G₁ and the Y electrode (i.e., while the voltages at the X electrode and the Y electrode are maintained at 0V), and the scan pulse is not supplied to the Y electrode of the eighth sub-group G₂₈ of the second row electrode group G₂ and the address pulse is not supplied to the A electrode while the sustain pulse supplied to the Y electrode of the first sub-group G₁₁ of the first row electrode group G₁ is increased from 0V to the Vs voltage. In addition, the scan pulse is sequentially supplied to the Y electrodes Y₁₂₆ to Y₁₂₇ of the eighth sub-group G₂₈ of the second row electrode group G₂ and the address pulse Va is supplied to the A electrode while the sustain pulse is maintained at the Vs voltage, and the scan pulse is not supplied to the Y electrode of the eighth sub-group G₂₈ of the second row electrode group G₂ and the address pulse Va is not supplied to the A electrode while the sustain pulse is decreased from the Vs voltage to 0V. While the voltages at the X and Y electrodes of the first sub-group G₁₁ of the first row electrode group G₁ are maintained at 0V, the scan pulse is supplied to the Y electrode Y₁₂₈ of the eighth sub-group G₂₈ of the second row electrode group G₂ and the address pulse Va is supplied to the A electrode.

As described, since the inrush current is not generated when the time for increasing of decreasing the sustain pulse supplied to the X electrode or the Y electrode of one row electrode group and the time for supplying the address pulse to the A electrode of another row electrode group are not overlapped, the EMI may be reduced.

While it has been described that the sustain pulses alternately have the Vs voltage and 0V voltage and the sustain pulses of opposite phases are supplied to the Y electrode and the X electrode in FIG. 5, FIG. 11A, and FIG. 11B, other types of sustain pulses can be supplied in the exemplary embodiment of the present invention. That is, in the exemplary embodiment of the present invention, the sustain pulse having the Vs voltage and a −Vs voltage can be supplied to the Y electrode while the X electrode is biased at the 0V voltage.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

According to the exemplary embodiment of the present invention, a plurality of row electrodes are grouped into first and second row electrode groups, and the respective row electrode groups are grouped into a plurality of sub-groups. In addition, in respective subfields of one field, the operation of the address period is performed for the respective sub-groups of the first and second row electrode groups, and the operation of the sustain period is performed between the address periods of the respective sub-groups. Furthermore, the operation of the address period of the respective sub-groups of the second row electrode group is performed while the operation of the sustain period of the respective sub-groups of the first row electrode group is performed, and the operation of the sustain period of the respective sub-groups of the first row electrode group is performed while the operation of the address period of the respective sub-groups of the second row electrode group is performed. As described above, priming particles formed during the sustain period are appropriately used during the address period because the address period is formed between the sustain periods of the respective sub-groups. Therefore, the scanning operation can be quickly performed by shortening the width of the scan pulse, and the length of one subfield can be reduced since the operation of the sustain period is performed during the address period.

In addition, the address periods of the respective subfields are formed in the selective erase method, the grayscales are expressed by the subsequent subfields before the erase discharge operation is performed in a corresponding subfield, and therefore a false contour does not occur. The power consumption can be reduced since one erase discharge is generated when any grayscale is expressed.

Since sufficient wall charges are formed when the selective write method is used during the address period in a subfield that is firstly positioned among the respective subfields, the erase discharge can be stably performed in the subsequent subfields using the selective erase method. Since the voltage gradually increasing and the voltage gradually decreasing are used during the reset period of the subfield using the selective write method, no strong discharge is generated during the reset period, and the contrast ratio can be increased.

When the time for increasing or decreasing the sustain pulse supplied to the X and Y electrodes of one row electrode group is not overlapped with the time for supplying the address pulse to the A electrode of another row electrode group, the EMI is reduced, and the discharge is more stably performed.

What is claimed is:

1. A method of driving a plasma display device by a plurality of subfields divided from one field, the plasma display device including a plurality of row electrodes, a plurality of column electrodes, and a plurality of discharge cells respectively defined by the plurality of row electrodes and the plurality of column electrodes, the method comprising:
dividing the plurality of row electrodes into a first row electrode group and a second row electrode groups, dividing the first row electrode group into a plurality of first sub-groups, and dividing the second row electrode group into a plurality of second sub-groups;
sustain-discharging a light emitting cell of at least one second sub-group selected from among the plurality of second sub-groups during a first period respectively corresponding to at least one second sub-group while selecting a non-light emitting cell from among light emitting cells of one first sub-group selected from among the plurality of first sub-groups, in respective first subfields of first subfield groups selected from among the plurality of subfields; and
sustain-discharging a light emitting cell of at least one first sub-group selected from among the plurality of first sub-groups during a second period respectively corresponding to at least one first sub-group while selecting a non-light emitting cell from among the light emitting cells of one second sub-group selected from among the plurality of second sub-groups, in the respective first subfields;
wherein the sustain-discharging of the light emitting cell of the at least one second sub-group further includes supplying a first sustain pulse and a second sustain pulse respectively having an opposite phase of a high level voltage and a low level voltage to a first electrode and a second electrode of the light emitting cell of the at least one second sub-group at least once; and
wherein the selecting of the non-light emitting cell from among the light emitting cells of the one first sub-group further includes supplying a first address pulse to a third electrode of the one sub-group while supplying either the high level voltage or the low level voltage to the first and second electrodes.

2. The method of claim 1, wherein the first address pulse is not supplied during at least one period selected from either a period in which the first sustain pulse and the second sustain pulse are increased from the low level voltage to the high level voltage or a period in which the first sustain pulse and the second sustain pulse are decreased from the high level voltage to the low level voltage.

3. The method of claim 1, wherein, in at least one first subfield selected from among the first subfield group, the light emitting cells of the plurality of the second sub-groups are sustain-discharged during the first period, and the light emitting cells of the plurality of first sub-groups are sustain-discharged during the second period.

4. The method of claim 1, wherein, in at least one first subfield selected from among the first subfield group, the first period corresponds to a period for selecting the non-light emitting cell from among the light emitting cells of the one first sub-group.

5. The method of claim 1, wherein, in at least one first subfield selected from among the first subfield group, the light emitting cell of the at least one second sub-group is not sustain-discharged during the period for selecting the non-light emitting cell from among the light emitting cells of the one first sub-group except for the first period, and the light emitting cell of the at least one first sub-group is not sustain-discharged during the period for selecting the non-light emitting cell from among the light emitting cells of the one second sub-group except for the second period.

6. The method of claim 1, wherein, in at least one first subfield of the first subfield group, the second sub-groups except for the at least one second sub-group selected from among the plurality of second sub-groups are not sustain-discharged during the period for selecting the non-light emitting cell from among the light emitting cells of the one first sub-group.

7. The method of claim 1, wherein the respective first subfields of the first subfield group respectively have the same weight value.

8. The method of claim 1, wherein some of the first subfields selected from among the first subfield group respectively have the same weight value, and the remaining first subfields respectively have a weight value that is lower than the weight value of the some of the first subfields.

9. The method of claim 1, wherein the first row electrode group comprises the first electrodes provided on an upper part of the plasma display device and selected from among the plurality of first electrodes, and the second row electrode group comprises the first electrodes provided on a lower part of the plasma display device and selected from among the plurality of first electrodes.

10. A plasma display device, comprising:
a Plasma Display Panel (PDP) including a plurality of first electrodes, a plurality of second electrodes, a plurality of third electrodes arranged in a direction crossing the first and second electrodes, and a plurality of cells defined by the first electrodes, the second electrodes, and the third electrodes;
a controller adapted to divide one field into a plurality of subfields, to divide the plurality of first electrodes into a first group and a second group, to divide first electrodes of the first group into a plurality of first sub-groups, and to divide first electrodes of the second group into a plurality of second sub-groups; and
a driver adapted to drive the plurality of first electrodes, the plurality of second electrodes, and the plurality of third electrodes;
wherein, in respective subsequent first subfields selected from among the plurality of subfields, the driver is adapted to:
select a non-light emitting cell from among light emitting cells of the respective first sub-groups during a first period for the respective first sub-groups, and to sustain-discharge a light emitting cell of at least one second sub-group selected from among the plurality of second sub-groups during a second period which is at least a part of the first period;
select a non-light emitting cell from among light emitting cells of the respective second sub-groups during a third period for the respective second sub-groups, the third period being arranged between neighboring first periods, to supply a first sustain pulse and a second sustain pulse respectively having a high level voltage and a low level voltage in opposite phases to the first and second electrodes of the light emitting cell of the at least one first sub-group selected from among the plurality of first sub-groups during a fourth period, the fourth period being at least a part of the third period, and to sustain-discharge the first and second electrodes; and
select the non-light emitting from among the light emitting cells of the one first sub-group by supplying a first address pulse to the third electrode of one sub-group while either the high level voltage or the low level voltage is supplied to the first and second electrodes.

11. The plasma display device of claim 10, wherein the driver does not supply the first address pulse during at least one period selected from either a period in which the first sustain pulse and the second sustain pulse are increased from the low level voltage to the high level voltage or a period in which the first sustain pulse and the second sustain pulse are decreased from the high level voltage to the low level voltage.

12. The plasma display device of claim 10, wherein, in a second subfield provided before the plurality of first subfields, the driver is adapted to select a light emitting cell from among discharge cells of the first group, to sustain-discharge the light emitting cell of the first group, to select a light emitting cell from among discharge cells of the second group, and to sustain-discharge the light emitting cell of the second group.

13. The plasma display device of claim 12, wherein the driver is adapted to set the plurality of discharge cells to be in a non-light emitting cell state before selecting the light emitting cell in the second subfield.

14. The plasma display device of claim 12, wherein the second period is shorter than the first period, and the fourth period is shorter than the third period.

15. The plasma display device of claim 12, wherein the second period is equal to the first period, and the fourth period is equal to the third period.
